(19) United States
(12) Patent Application Publication
(10) Pub. No.: US 2007/0096888 A1
(43) Pub. Date: May 3, 2007

(54) Low Frequency Receiver with Magnetically Sensitive Detector

(75) Inventor: Bjorn Blixhavn, Horten (NO)

Correspondence Address: EDELL, SHAPIRO & FINNAN, LLC, 1901 RESEARCH BOULEVARD, SUITE 400, ROCKVILLE, MD, 20850, US

(73) Assignee: INFINEON TECHNOLOGIES SENSONOR AS, Horten (NO)

(21) Appl. No.: 11/539,192

(22) Filed: Oct. 6, 2006

(30) Foreign Application Priority Data
Oct. 10, 2005 (EP) 05256284.0

(51) Int. Cl. B60C 23/00

(52) U.S. Cl. 340/445

(57) ABSTRACT

A receiver for a wheel module of a tire pressure monitoring system (TPMS) includes: a giant magnetoresistive (GMR) detector element; a receiver element, and a signal processor connected to the detector and receiver elements. The receiver is arranged to detect a low frequency signal transmitted by a tire pressure monitoring system (TPMS) transmitter.

### CROSS REFERENCE TO RELATED APPLICATIONS

This application claims priority under 35 U.S.C. §119 to application No. EP05256284.0 filed on Oct. 10, 2005, entitled “Low Frequency Receiver with Magnetically Sensitive Detector Element,” the entire contents of which are hereby incorporated by reference.

### FIELD OF THE INVENTION

The present invention relates to a tire pressure monitoring system (TPMS).

### BACKGROUND

TPMSs are becoming a common feature in modem vehicles. In many TPMSs, it is a requirement to include a communication channel which can wake up or give short commands to the wheel module of the vehicle with the TPMS. The communication channel is capable, during assembly of the wheel module, of transferring the wheel module from a storage state into an operating state, and also capable of triggering the immediate transfer of measurement data during testing or calibration procedures. During servicing of a vehicle, such as replacing worn tires or changing between summer and winter tires, the channel is used to teach the vehicle the location of the individual tires. The channel, in combination with transmitters placed at each wheel, can also be used for communication with the wheel module during driving. The added cost of placing transmitters at each wheel is expensive.

Considering the harsh environment of which a TPMS operates within and due to the rotation of the wheels, it is undesirable to implement the communication channel via galvanic contact. Therefore, a non-contact communication system is used which requires additional components in the system to receive the transmitted signal.

At present, the most common way of implementing the communication channel to the TPMS wheel module is via a low frequency (LF) channel which transmits electromagnetic waves at a frequency of typically 125 kHz. This means that the wheel module contains a resonant antenna, i.e., tank circuit, including: a coil, a capacitor, and optionally a resistor to limit a Q-factor of the circuit.

A disadvantage of the current technology is the need for the antenna coil to detect the LF field. LF coils are relatively large, heavy and expensive components and therefore are not desirable as design requirements continuously demand for smaller, lighter and cheaper components.

A further disadvantage of the current technology is that at strong LF fields, the antenna circuit may induce high currents into the input amplifier. Precautions are needed to ensure that these currents do not harm the receiver.

### SUMMARY

According to the present invention there is provided a receiver for a wheel module in a tire pressure monitoring system (TPMS), the receiver including: a giant magnetoresistive (GMR) detector element, a receiver element, and a signal processor connected to the detector and receiver elements. The receiver is arranged to detect a low frequency signal transmitted by a TPMS transmitter.

The present invention advantageously detects the electromagnetic LF field. The detecting element has negligible mass, and can be integrated into the application specific integrated circuit (ASIC) of the wheel module. The detecting element is passive, and cannot generate voltages or currents that can harm the ASIC. The device offers significant improvements in applications requiring optimal size, weight and cost.

The above and still further features and advantages of the present invention will become apparent upon consideration of the following definitions, descriptions and descriptive figures of specific embodiments thereof, wherein like reference numerals in the various figures are utilized to designate like components. While these descriptions go into specific details of the device, it should be understood that variations may and do exist and would be apparent to those skilled in the art based on the descriptions herein.

### BRIEF DESCRIPTION OF THE DRAWINGS

The present invention is explained in more detail below with reference to exemplary embodiments, where:

FIG. 1 shows an example of a receiver in accordance with the present invention; and

FIG. 2 illustrates a transmitter-receiver chain incorporating the receiver of the present invention.

### DETAILED DESCRIPTION

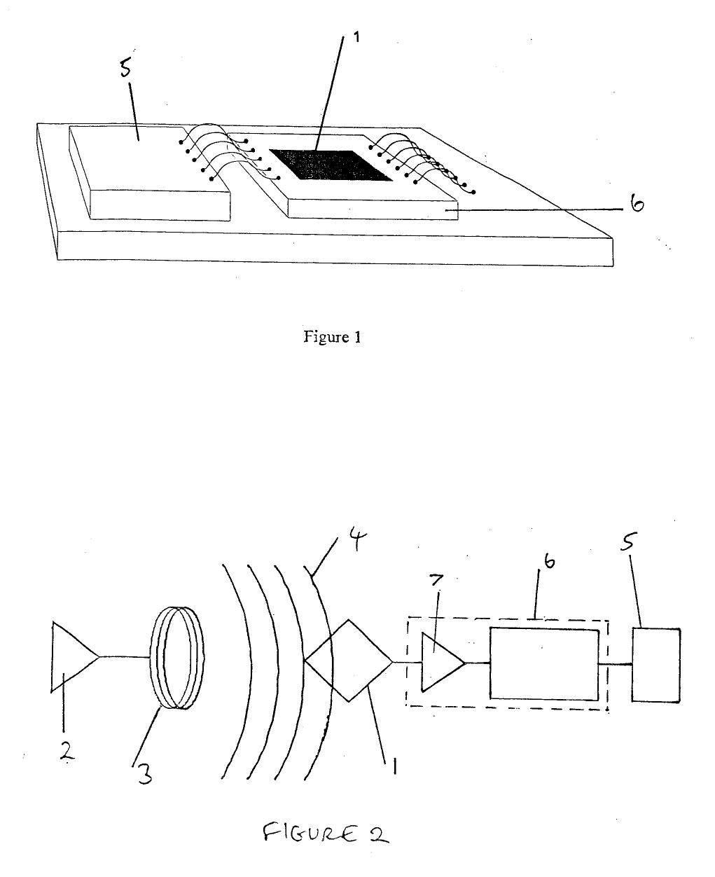

Referring to FIG. 1, an example of a receiver according to the present invention includes a detecting element 1 disposed on top of a signal processing integrated circuit 6. A sensitive receiver element 7, shown in FIG. 2, which may be, for example, tuned to 125 kHz, is included as a component of the integrated circuit 6. A TPMS sensor chip 5 is connected to the signal processing circuit.

The detecting element 1 of the described device comprises of a highly sensitive magnetoresistive film. Current examples are giant magnetoresistive (GMR) film, which has a change in resistivity of 20% or more when introduced to relatively weak magnetic fields. In the case of colossal magnetoresistive (CMR) film, CMR films have orders of magnitude changes in resistivity when introduced to a magnetic field. For simplicity, GMR is used to refer to all of these large magnetoresistive effects throughout the description and claims. The film is deposited on the top surface of the integrated circuit, and patterned into a sensing structure, typically a full bridge or half bridge. In one embodiment, the GMR film is sputtered on top of the passivation layer. This is compatible with standard CMOS technology.

The film of the detecting element 1 is connected to the integrated circuit via metal contacts such as tungsten plugs that penetrate the top passivating layer of the chip. There are usually four connections to the active circuits of the integrated circuit 6. The bridge signal is amplified, filtered and detected by the electronic circuits.

The GMR detector element can also be deposited on any other type of integrated circuit, or included as a separate chip, connected to the signal processing chip via bonding wires. In a multi-chip sensor, the GMR structure can also be included on the sensor chip.

The signal processing electronics can include filters to admit only a certain range of signal frequencies, and detector circuits to distinguish between signals above or below a certain magnitude. More complex decoders, that can receive address and data modulated on the detected signal and act on the received data, are also possible.

Signaling frequencies other than 125 kHz are also possible.

Referring to FIG. 2, the TPMS transmitter 2 transmits data via an antenna coil 3, in the form of LF electromagnetic waves 4. The signals are detected via the GMR element 1 and are passed via a receiver element 7 to the signal processing circuits 6 of the chip. For the majority of applications, an LF transmitter can be placed close to a wheel module such that a sufficient signal, suitable for communicating with the described device, is transmitted.

While the invention has been described in detail with reference to specific embodiments thereof, it will be apparent to one of ordinary skill in the art that various changes and modifications can be made therein without departing from the spirit and scope thereof. Accordingly, it is intended that the present invention covers the modifications and variations of this device provided they come within the scope of the appended claims and their equivalents.

What is claimed is:

1. A tire pressure monitoring system (TPMS) comprising a wheel module including a receiver, the receiver comprising:
a giant magnetoresistive (GMR) detector element;
a receiver element; and
a signal processor connected to the detector and receiver elements;
wherein the receiver is arranged such that the GMR detector element detects a low frequency signal transmitted by a TPMS transmitter.

2. The system according to claim 1, wherein the detector element comprises a film.

3. The system according to claim 1, wherein the detector element is deposited on the surface of an integrated circuit.

4. The system according to claim 2, wherein the detector element is deposited on the surface of an integrated circuit.

5. The system according to claim 1, wherein the receiver element is tuned to a frequency between 80 and 170 kHz inclusive.

6. The system according to claim 4, wherein the receiver element is tuned to 125 kHz.
